(19) United States
(12) Patent Application Publication
(10) Pub. No.: US 2026/0028939 A1
(43) Pub. Date: Jan. 29, 2026

(54) AIRCRAFT PROPULSION ASSEMBLY COMPRISING AN IMPROVED COWLING PANEL

(71) Applicant: SAFRAN NACELLES, GONFREVILLE-L'ORCHER (FR)

(72) Inventor: Pierre Charles CARUEL, MOISSY-CRAMAYEL (FR)

(73) Assignee: SAFRAN NACELLES, GONFREVILLE-L'ORCHER (FR)

(21) Appl. No.: 18/998,225

(22) PCT Filed: Jul. 26, 2023
(86) PCT No.: PCT/FR2023/051171

§ 371 Date: Jan. 24, 2025

(30) Foreign Application Priority Data
Jul. 28, 2022 (FR) 2207817

(51) Int. Cl. F02C 7/24; B23K 26/21; B64D 29/00

(52) U.S. Cl. CPC F02C 7/24; B23K 26/21; B64D 29/00; F05D 2230/237; F05D 2250/283; F05D 2300/133; F05D 2300/173

(57) ABSTRACT

A propulsion assembly for an aircraft, comprising a cowling panel that is installed in a high-temperature region of the propulsion assembly and provides a flameproof barrier, the panel comprising a sandwich-like structure that comprises a first skin, a second skin, and a central core connecting the first and second skins, where the first skin is made of a single first material, this material having properties of mechanical strength at temperature and of being flameproof, in that the second skin is made of a second material which is different from the first material and is without these properties, and in that the central core is made of one of these first or second materials or of a material that is different from these first or second materials.

### TECHNICAL FIELD OF THE INVENTION

The invention relates to a propulsion assembly for an aircraft, this assembly comprising a cowling panel, equipped with thermal protection and flameproof protection, and a method for manufacturing such a panel.

### TECHNICAL BACKGROUND

Prior art is known from the documents FR2 940 369 A1, FR2 938 014 A1, WO 92/00183 A1, US 2018/218723 A1 and US 2021/0355880 A1.

The cowling panels are widely used in the aircraft propulsion assemblies, both as nacelle panels and as panels inside the turbomachine.

In particular, some of these panels may be subjected to high temperatures. This is particularly the case, in the case of a propulsion assembly comprising a turbofan engine, of panels arranged around an engine compartment surrounding the gas generator of the turbomachine, also referred to as the “core area”.

The engine compartment comprises an outer shell serving as a fairing and referred to inner fixed structure (also referred as IFS) surrounding the core area. This fixed structure is subject to high thermal stresses due to its proximity to the hot parts of the engine, and is generally protected using thermal protection panels, which keep the walls of the nacelle at acceptable, compatible temperatures made from materials that are simple and inexpensive to implement. These thermal protection panels also act as a flameproof barrier and may be used in other areas of the nacelle where there is a risk of fire.

In order to protect the inner structure, it is known to use protective cowling panels, arranged in particular on the engine compartment side, and comprising at least one insulating blanket, generally made from silica fibers, ceramic or a microporous material, this blanket being clamped between strips generally made of stainless steel.

Panels configured to equip the thrust reversers are known to be designed in the form of a sandwich-like structure comprising a first skin equipped for thermal and flameproof protection, a second skin and a central core connecting the first and second skins.

According to a first known concept, it was proposed to make this sandwich-like structure entirely of titanium. The disadvantage of this design is that it is particularly expensive.

According to a second known concept, it was proposed to make this sandwich-like structure entirely of stainless steel. This design has the disadvantage of being particularly cumbersome.

According to a third known design, the document FR-3.044.960-A1 proposes an aluminum sandwich-like structure, the first skin of which is covered with tiles made of composite materials comprising a fire-resistant ceramic matrix. The disadvantage of this design is that it takes a long time to assemble the tiles to the first skin.

According to a fourth known design, the document FR-3.044.961-A1 proposes a sandwich-like structure wherein the first skin receives a protective layer comprising a ceramic matrix composite material, the two skins and the central core being made of aluminum, for example. To deposit the protective layer, part of the thickness of the first skin is converted to alumina by oxidation, then a fibrous layer comprising fibers of a ceramic material is deposited on it, and finally the fibrous layer is sintered at a temperature that allows the ceramic material to consolidate. This design also has the disadvantage of being particularly time-consuming and expensive.

There is therefore a real need for a propulsion assembly panel that may be manufactured quickly and cost-effectively, i.e. with a minimum of operations.

### SUMMARY OF THE INVENTION

To this end, the invention proposes a propulsion assembly for an aircraft, this propulsion assembly comprising a cowling panel installed in a high-temperature area of said propulsion assembly and providing a flameproof barrier, said cowling panel comprising a sandwich-like structure comprising a first skin, a second skin, and a central core connecting the first and second skins,

characterized in that the first skin is made of a single first material, this material having properties of mechanical resistance to high temperatures and of flameproof barrier allowing said first skin to withstand up to a temperature determined between 350 and 400° C., and to be exposed directly to a flame without igniting or being passed through by said flame for at least 15 minutes, in that the second skin is made of a second material which is different from the first material and is without said properties, and in that the central core is made of one of said first and second materials or of a material different from said first and second materials.

In the present application, mechanical resistance to high temperatures is taken to mean the ability of the material to exhibit mechanical characteristics that allow it to withstand the stresses for which it is used without the addition of further thermal protection, i.e. typically to exhibit at least 50% of its usual mechanical characteristics at 20° C.

A flameproof barrier is also defined as the ability of the material to be exposed directly to a flame without itself igniting and without the flame passing through it.

This characteristic is particularly advantageous, as a thermal protection of the panel is no longer necessary or may be of lesser thickness than that of panels known in the prior art, and a flameproof barrier may be provided solely by the single material of the first skin, without this undergoing any treatment or being covered with any protection element. The central core and the second skin may therefore be made more cheaply from a material that does not have these properties and is therefore less expensive.

According to other characteristics of the propulsion assembly:
the sandwich-like structure may be made of metallic materials, in which case:
   the first skin is a titanium or stainless steel plate,
   the central core comprises at least one layer of aluminum alloy comprising regularly distributed spacers extending between the first and second skins,
   the second skin is an aluminum alloy plate.
in this case, the first skin is able to withstand up to a temperature of 350 to 400° C.,
the sandwich-like structure may be made of thermoplastic composite materials, in which case:
   the first skin is a composite plate made of thermoplastic material with a glass transition temperature above 140° Celsius, in particular of the PEEK or PEKK, PEI, PAI or PPSU type,
   the central core comprises at least one layer of regularly distributed spacers extending between the first and second skins, said layer being made of a thermoplastic material, in particular of the PA, PAN or PPS type, having a glass transition temperature melting point lower than that of the material of the first skin, and
   the second skin is a plate made from the same thermoplastic material as the central core,
when the first skin is made of Poly Ether Imide (PEI), it is able to withstand a temperature of 150 to 210° C.

Whatever the materials used, depending on other characteristics of the propulsion assembly:
each layer comprises spacers each having the general shape of a hollow pyramid with a flat truncated top and an open base whose sides are connected to the sides of the bases of the adjacent spacers by a wall of the layer which is parallel to the skins and which extends between the pyramids,
the central core comprises a single layer of spacers which is attached to the first skin by its wall and which is attached to the second skin by the flat truncated tops of its pyramids.
alternatively, the central core comprises two superimposed layers, each layer being attached to a corresponding skin by its wall and the layers being attached to each other by the flat truncated tops of their pyramids arranged head to tail,
at least one face of each pyramid comprises at least one acoustic perforation.
the central core may comprise a single layer of tubular grooves in the form of honeycombs, in particular hexagonal grooves, the ends of which comprise dropped edges which are connected respectively to the first and second skins,
the central core may comprise a single layer formed of a grid comprising an arrangement of first blades parallel to one another, and second blades parallel to one another, the second blades being substantially perpendicular to the first blades and embedded in the first blades.

The invention also relates to a method for manufacturing a propulsion assembly of the type described above, characterized in that it comprises at least a first step of welding the first skin to the central core and at least a second step of welding or brazing the second skin to the central core.

More particularly, in the case of a central core comprising a layer of pyramidal spacers, this method comprises:
a first step of welding the single layer of the central core to the first skin, the welding being carried out by moving a welding tool over the wall of the layer along a predetermined path between the pyramids,
a second step of brazing or gluing the second skin to the flat truncated tops of the pyramids of the single layer of the central core.

In the case of a central core comprising two layers of pyramidal spacers, this method comprises:
a first step of welding each of the two layers configured to form the central core to the first skin and the second skin respectively, the welding being carried out by moving a welding tool over the wall of each layer along a path between the pyramids of each layer,
a second step of brazing between the flat truncated tops of the pyramids of each of the two layers to join them together and form the central core.

In other embodiments of the central core, this method comprises:
a first step of welding the central core to the first skin, the welding being carried out by a welding tool,
a second step of brazing or gluing the second skin to the central core.

Advantageously, in a method applied to metallic materials and a central core comprising pyramidal spacers, a friction stir tool is used as the welding tool in the first step. Alternatively, a laser welding tool or spot welding tool may be used as the welding tool.

Preferably, prior to this first step, a preliminary tacking step is carried out, during which tacking is performed by spot welding between the wall of the layer of the central core and the first skin.

Advantageously, in a method applied to thermoplastic materials, an ultrasonic welding tool or an induction welding tool is used as the welding tool in the first step.

### BRIEF DESCRIPTION OF THE FIGURES

Further characteristics and advantages of the invention will become apparent from the following detailed description, for the understanding of which reference is made to the attached drawings wherein:

FIG. 1 is a longitudinal sectional view of an aircraft propulsion assembly;

FIG. 2 is a longitudinal sectional view of a cowling panel according to a first prior art;

FIG. 3 is a longitudinal sectional view of a cowling panel according to a second prior art;

FIG. 4 is a principle longitudinal sectional view of a cowling panel according to the invention;

FIG. 5 is a perspective view of a first embodiment of a central core joined to a first skin of a cowling panel according to the invention;

FIG. 6 is a flat view of a blank used to produce the central core shown in FIG. 5;

FIG. 7 is a perspective view of a variant of the first embodiment of the central core of FIG. 5 assembled with a first skin of a cowling panel according to the invention;

FIG. 8 is a flat view illustrating the path of a welding tool during the assembly of the central core to the first skin of the cowling panel;

FIG. 9 is a perspective view illustrating the assembly of the second skin of a cowling panel according to the invention to the central core of FIG. 5;

FIG. 10 is a perspective view of the assembly of a cowling panel comprising a central core according to a second embodiment;

FIG. 11 is a perspective view of a first series of blades used in a second embodiment of a central core for a cowling panel according to the invention;

FIG. 12 is a perspective view of a second series of blades used in a second embodiment of a central core for a cowling panel according to the invention;

FIG. 13 is a perspective view of the second embodiment of the central core for the cowling panel according to the invention;

FIG. 14 is a perspective view of a variant of the second embodiment of the central core for the cowling panel according to the invention;

FIG. 15 is a perspective view of a variant of the third embodiment of the central core for the cowling panel according to the invention;

FIG. 16 is a block diagram illustrating the manufacturing steps of a propulsion assembly according to the invention.

### DETAILED DESCRIPTION OF THE INVENTION

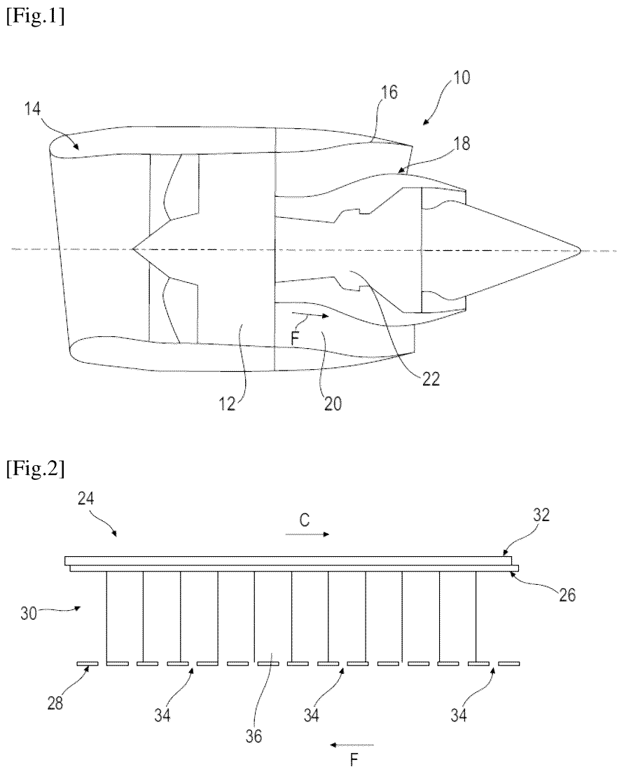

FIG. 1 shows an aircraft propulsion assembly 10, comprising a turbojet engine 12 housed in a nacelle 14. The nacelle 14 comprises an outer fixed structure 16 or OFS and an inner fixed structure 18 or IFS delimiting an engine compartment 22 of the turbojet engine. These two structures 16, 18 are concentric and define a secondary air vein 20 through which the “cold” air F circulates when the turbojet engine 12 is operating. The inner fixed structure 18 therefore forms the outer shell of the engine compartment 22 of the turbojet engine 12, which is bathed by the “hot” air C heated around the hot casings of the gas generator of the turbojet engine, in particular by the shell of the combustion chamber and the turbine casings downstream of it, which form the outer shell of the primary vein of the turbojet engine. The inner fixed structure 18 may comprise one or more cowling panels in accordance with the invention.

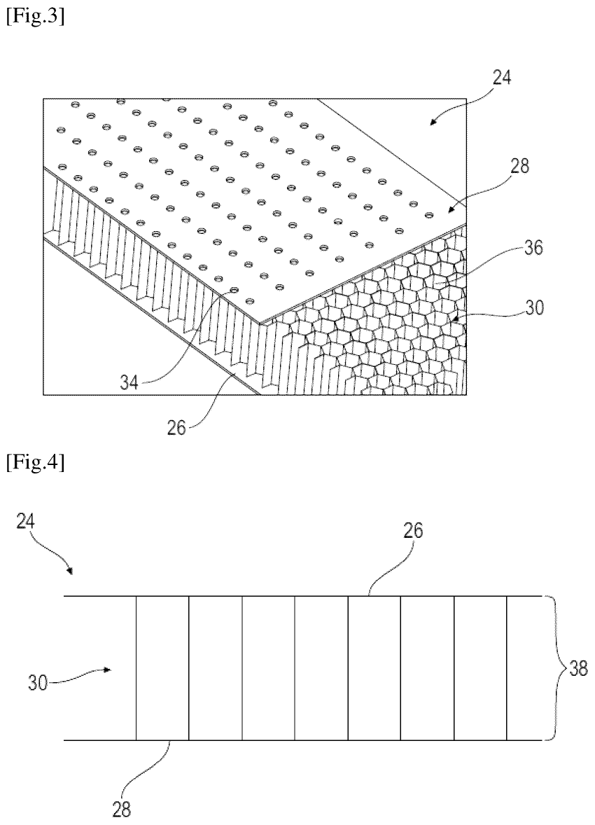

Conventionally, as shown in FIGS. 2 and 3, such a cowling panel 24 provides mechanical resistance to high temperatures and acts as a flameproof barrier.

In the present application, mechanical resistance to high temperatures is taken to mean the ability of the material to have mechanical characteristics allowing it to withstand the stresses for which it is used without the addition of any further thermal protection, i.e. typically to have at least 50% of its usual mechanical characteristics at 20° C., such as, for example, and without limiting the invention, mechanical tensile strength, practical shear strength or stiffness.

Such a material therefore retains its integrity at operating temperature.

A flameproof barrier is also defined as the property of the panel to be exposed directly to a flame without itself igniting and without being passed through by the flame.

The panel 24 comprises a sandwich-like structure comprising a first skin 26, a second skin 28 and a central core 30 connecting the first skin 26 and second skin 28.

The first skin 26 is bathed by air flow C and the second skin 28 is bathed by air flow F. According to a first prior art which was represented in FIG. 3, the structure of the cowling panel 24 is an aluminum alloy structure, the first skin 26 and the second skin 28 made of aluminum being assembled by any suitable method, in particular by gluing, on either side of a layer of aluminum honeycombs. The first skin 26 receives a protective layer comprising a ceramic matrix composite material, the two skins and the central core 30 being made of aluminum, for example. To deposit the protective layer, part of the thickness of the first skin 26 is converted to alumina by oxidation, then a fibrous layer 32 comprising fibers of a ceramic material is deposited on it, and finally the fibrous layer is sintered at a temperature allowing the ceramic material to consolidate. The second skin 28 comprises acoustic perforations that communicate with grooves 36 in the central core 30. This design requires a special treatment of the first skin 26, consisting of several operations, and as a result this design has the disadvantage of being particularly time-consuming and expensive. According to another prior art, which has not been shown, the first skin 26 may be covered with fitted tiles having thermal and flameproof protection characteristics.

According to a second prior art which has been represented in FIG. 3, the structure of the cowling panel 24 is a titanium, titanium alloy or stainless steel structure, which comprises the first skin 26 and the second skin 28 assembled on either side of a titanium or stainless steel honeycomb layer forming the central core 30. In the same way as in the previous embodiment, the second skin 28 comprises acoustic perforations 34 which communicate with the grooves 36 of the honeycomb layer. This design is simpler to assemble, but is still very expensive if titanium is used for the entire cowling panel 24, or very heavy if stainless steel is used.

Such cowling panels 24 may also be used to form thrust reverser flaps, placed at the outlet of the turbojet engine, in which case the first skin 26 is likely to be exposed to hot gases leaving the turbojet engine.

However, it is not necessary to provide a central core 30 and a second skin 28 made of titanium as these are not directly exposed to high-temperature gases.

The invention remedies the above disadvantages by providing a panel 24 with a simplified design.

In accordance with the invention, as shown in FIG. 4, the first skin 26 is made from a single first material. This design allows the first skin 26 to be assembled and used directly, without any specific treatment to give it thermal and flameproof protection characteristics. It is the material of the first skin 26 that is chosen, between the first 26 and the second skin 28, to offer the best properties in terms of mechanical strength at high temperatures and flameproof barrier.

By mechanical resistance to high temperatures, we mean the ability of the material to exhibit mechanical characteristics that allow it to withstand the stresses for which it is used without the addition of any further thermal protection, i.e. typically to exhibit at least 50% of its usual mechanical characteristics at 20° C., such as, for example and without limiting the invention, mechanical tensile strength, practical shear strength or stiffness.

Flameproof protection means that the panel has the ability to be exposed directly to a flame without igniting.

The second skin 28 is made from a second material, different from the first material, which is without the aforementioned mechanical temperature resistance and flameproof resistance properties.

Finally, the central core 30 is made from one of said first and second materials or from a material different from said first and second materials.

Preferably, to simplify the assembly of the panel 24, the material of the central core will be chosen to be identical to the material of the second skin 28.

This design is particularly advantageous because it allows to eliminate the need for special treatment of the first skin 26. Choosing a different, less expensive material for the second skin 28 also reduces the cost of such a panel 24.

As will be seen later in this description, the mechanical temperature resistance and flameproof barrier properties of the material of the first skin 26 and the choice of a different material for the second skin 28 require a particular method for attaching the first skin 26 to the central core 30. The method for attaching the second skin 28 to the central core 30 may be the same or different.

Thus, in general, a method for manufacturing a propulsion assembly according to the invention comprises at least one step of welding the first skin 26 to the central core 30 and at least one step of welding or brazing the second skin to the central core.

According to the invention, the panel 24 may be produced with two embodiments, namely a first embodiment wherein it is made of metallic materials, and a second embodiment wherein it is made of thermoplastic composite materials. In each of these two embodiments, there are three main ways wherein the central core 30 may be made, depending on its structure.

In the first embodiment of the propulsion assembly, the sandwich-like structure is made of metallic materials.

The first skin 26 is a titanium or stainless steel plate. As a result, the first skin 26 intrinsically comprises mechanical temperature resistance and flameproof barrier characteristics which mean that it does not require additional treatment or the addition of protective tiles or covering with thermal protection in order to have the above-mentioned characteristics.

The material of the first skin may thus be exposed to temperatures of up to 350 to 400° C. without substantial changes to its mechanical characteristics, and may be exposed directly to a flame without igniting and without being passed through by the flame.

As the first skin 26 has all the required mechanical temperature resistance and flameproof barrier characteristics, it is not necessary for the other materials of the panel 24 to be made of stainless steel or titanium.

The second skin 28 is an aluminum alloy plate. The central core 30, for its part, comprises at least one layer 38, preferably made of aluminum alloy, and comprising regularly distributed spacers extending between the first and second skins 26, 28. These spacers will be described later in this description. The use of an aluminum alloy means that conduction through the second skin and the core keeps the whole part at a low temperature.

In the second embodiment of the propulsion assembly, the sandwich-like structure is made of thermoplastic materials.

The first skin 26 is a plate of thermoplastic material with a melting point above 340 degrees, such as PEEK (Poly Ether Ether Ketone with a melting temperature of 343° C.) or PEKK (Poly Ether Cetone Cetone with a melting temperature of 386° C.), or a similar material such as PEI (Poly Ether Imide), PAI (Polyamide-Imide) or PPSU (Poly Phenyl Sulfone). This thermoplastic material is also capable of being exposed directly to a flame without igniting itself and of forming the flameproof barrier, for a period of exposure of at least 15 minutes. When the material of the first skin is Poly Ether Imide (PEI), it may withstand temperatures of 150 to 210° C.

Additional thermal protection may be added to the first skin to ensure that the temperature around the first skin is compatible with the ability of stress passage, and in particular below its glass transition temperature. It will be thinner than in the case of panels known in the prior art with a glued panel made from a thermoset matrix composite material, as the admissible temperatures are higher. By way of example, for a first skin made of PEI, it is estimated that, thanks to the invention, the thickness of this additional protection may be reduced from 20 mm to 10 mm compared with a conventional first skin made from a thermoset matrix.

In the same way as above, the central core 30 comprises at least one layer 38 of regularly distributed spacers extending between the first and second skins 26, 28. This layer is made of a thermoplastic material such as PA (Poly Amide), PAN (Poly Acrylo Nitrile), with a lower glass transition temperature than the material of the first layer (approximately 105° C.) or PPS (Poly Phenylene Sulfide, with a lower glass transition temperature than the material of the first layer (approximately 85° C.), or a similar material.

Finally, the second skin 28 is a plate made from the same thermoplastic material as the central core 30, i.e. a plastic material of the PA, PAN or PPS type.

As mentioned above, in each of these two embodiments of the panel 24, which depend on the materials used, the central core 24 may be designed in several embodiments depending on its structure.

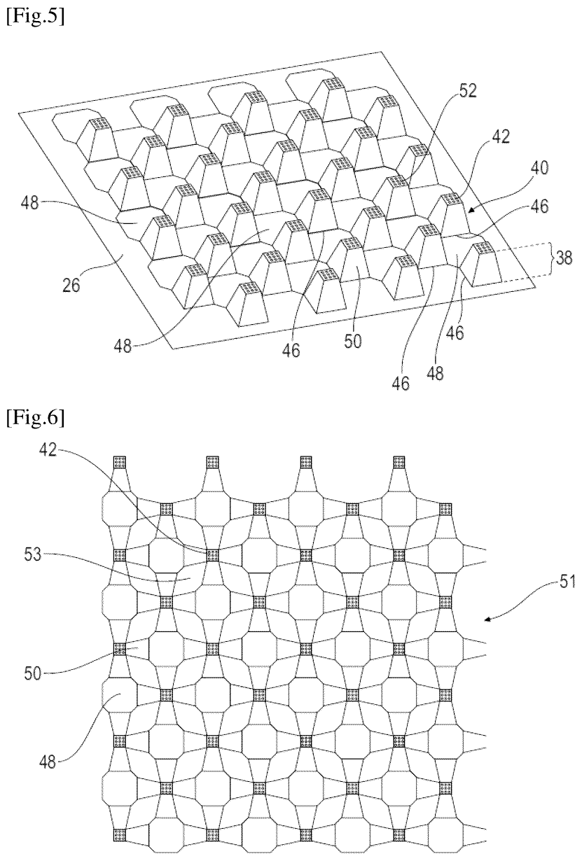

Thus, according to a first embodiment which has been represented in FIGS. 5 to 10, each layer 38 comprises spacers 40 each having the general shape of a hollow pyramid with a flat truncated top 42 and an open base 44 whose sides 46 are connected to the sides 46 of the bases 44 of the adjacent spacers 40 by a wall 48 of the layer which is parallel to the skins 26, 28 and which extends between the pyramids. In addition to their truncated tops 42, the pyramids comprise sloping flanks 50.

Each layer of pyramidal spacers is obtained from a flat blank 51, as shown in FIG. 6. This flat blank 51 is configured to be deformed in three dimensions by simple folding to form the hollow pyramid-shaped spacers 40. To this end, the flat blank 51 comprises cut-outs 53 which are configured to disappear when the inclined flanks 50 meet.

Depending on the first or second embodiment of the panel 24 chosen, the shape of the flat blank 51 is different. In the case of a metallic material, this is simply pressed onto a matrix, whereas in the case of a thermoplastic material, this is deformed by heating, also on a matrix.

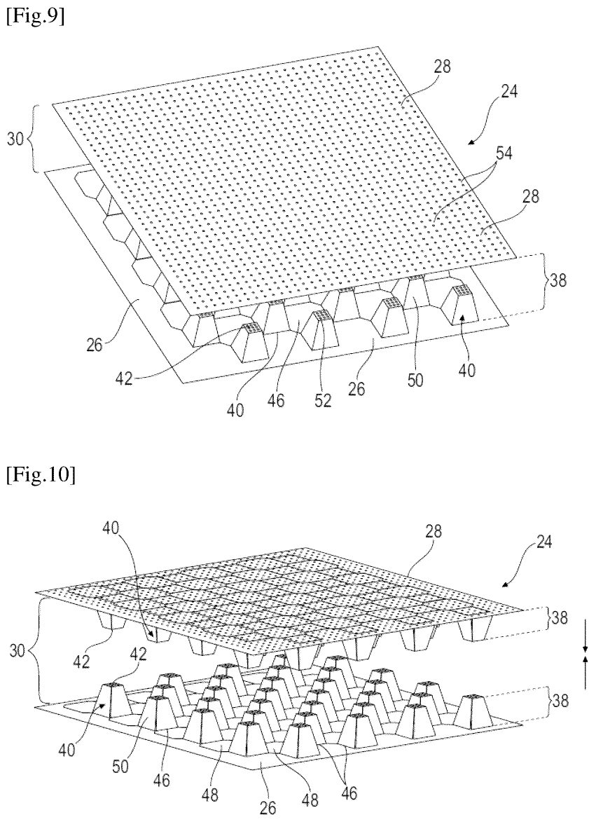

FIG. 5 shows a layer 38 of spacers 40 attached to the first skin 26. By adding the second skin 28, as shown in FIG. 9, a first variant of this first embodiment of the central core 30 results in a panel 24 comprising only one layer 38 of spacers 40 between the first skin 26 and the second skin 28.

The panel 24 does not necessarily comprise only one layer of spacers 38. In a second embodiment of the central core 30, it may comprise two, as shown in FIG. 10.

In the first variant of the first embodiment of the central core 30, the single layer 38 of spacers 40 is attached to the first skin 26 by its wall 48 and is attached to the second skin 28 by the flat truncated tops 42 of its pyramids 40, as shown in FIG. 9.

In both variants of this first embodiment, it should be noted that, preferably, at least one face of each of the pyramids 40 comprises at least one acoustic perforation 52, 54.

Thus, as illustrated in FIGS. 5, 6, 9 and 10, the flat truncated tops 42 of the pyramids 40 may comprise acoustic perforations 52.

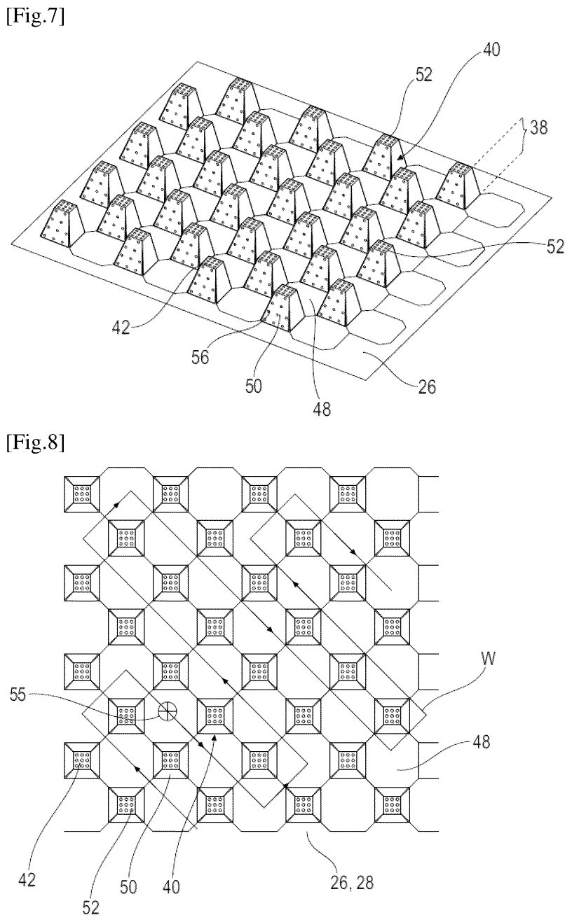

The acoustic perforations 52 are configured to communicate with acoustic perforations 54 formed in the second skin 28, as shown in FIG. 9. Alternatively, or in combination with these perforations 52, the flanks 50 of the pyramids 40 may comprise acoustic perforations 56, as shown in FIG. 7.

In all cases, these perforations 52, 54 allow the outside air bathing the second skin 28 to communicate with the inside of the pyramid spacers 40, which is trapped between the outer walls of the pyramids and the first skin 26. In this way, the inside of the pyramidal spacers 40 forms an acoustic resonator.

In the two variants of this first embodiment, the method for manufacturing the panel 24 differs depending on the variant envisaged, i.e. depending on whether the central core 30 comprises one or two layers 38.

In the first variant of the first embodiment, the method for manufacturing the panel 24 comprises, as illustrated in FIGS. 8 and 16, a first step ET1 of welding the single layer 38 of the central core 30 to the first skin 26, the welding being carried out by moving a welding tool 55 over the wall 48 of the layer 38 along a predetermined path W between the pyramids 40. The determined path W preferably winds between the pyramids 40 to cover as much of the surface of the wall 48 as possible.

Then, as illustrated in FIGS. 9 and 16, the method comprises a second step ET2 of brazing or gluing the second skin 28 to the flat truncated tops 42 of the pyramids 40 of the single layer 38 of the central core 30.

More particularly, when the materials are metallic, the first welding step ET1 is carried out preferably using a friction stirring tool as the welding tool, consisting, in a manner known per se, of a rotating pin which is moved along the wall 48 so that rotation of the pin at high speed renders the material of the wall 48 and that of the first skin 26 pasty by mixing them intimately. Alternatively, a laser welding tool or spot welding tool may be used as a welding tool.

Preferably, the method may also comprise a preliminary tacking step ET0 prior to the first step ET1, during which a tacking is performed by a spot welding between the wall 48 of the layer 38 and the first skin 26.

The second step ET2 is in this case a brazing step using a filler metal between the flat truncated tops 42 of the pyramids 40 and the second skin 28.

When the materials are thermoplastic, during the first step ET1, an ultrasonic welding tool or an induction welding tool is preferably used as the welding tool. In this case, the second step ET2 is either a brazing step using a thermoplastic filler material between the flat truncated tops 42 of the pyramids 40 and the second skin 28, or a step of gluing the second skin 28 to the flat truncated tops 42 of the pyramids 40, or an ultrasonic or induction welding step.

In the second variant of the first embodiment of the central core 30, as may be seen in FIG. 10, it comprises two superimposed layers 38. Each layer 38 is attached to a corresponding skin 26 or 28 by its wall 48 and the two layers 38 are attached to each other by the flat truncated tops 42 of their pyramids 40 arranged head to tail.

In this case, the method for manufacturing the propulsion assembly is slightly different and comprises, with regard to the manufacture of the panels 24, a first step of welding each of the two layers 38 configured to form the central core 30 to the first skin 26 and the second skin 28 respectively, the welding being carried out by moving the welding tool 55 over the wall of each layer 48 following the path W between the pyramids of each layer 38.

As previously, the welding is carried out, in the case of metallic materials, by friction stir welding, laser welding or spot welding, and, in the case of thermoplastic materials, by ultrasonic or induction welding.

Then, the method for manufacturing the propulsion assembly comprises a second step ET2 of brazing between the flat truncated tops 42 of the pyramids 40 of each of the two layers 38 to join them and form the central core 30, as shown by the arrows in FIG. 10. The brazing is carried out, in the case of metallic materials, with the aid of a filler metal, or in the case of thermoplastic materials, with the aid of a thermoplastic filler material.

In the two variants of this first embodiment, the use of truncated pyramids 40 allows a degree of freedom in the vertical direction at the time of brazing, which allows to accommodate greater tolerances in order to achieve good docking of the parts and good diffusion of the filler material between the two parts to be assembled.

In each of the two embodiments of the panel 24, i.e. metal or plastic, there are two other embodiments of the central core 30.

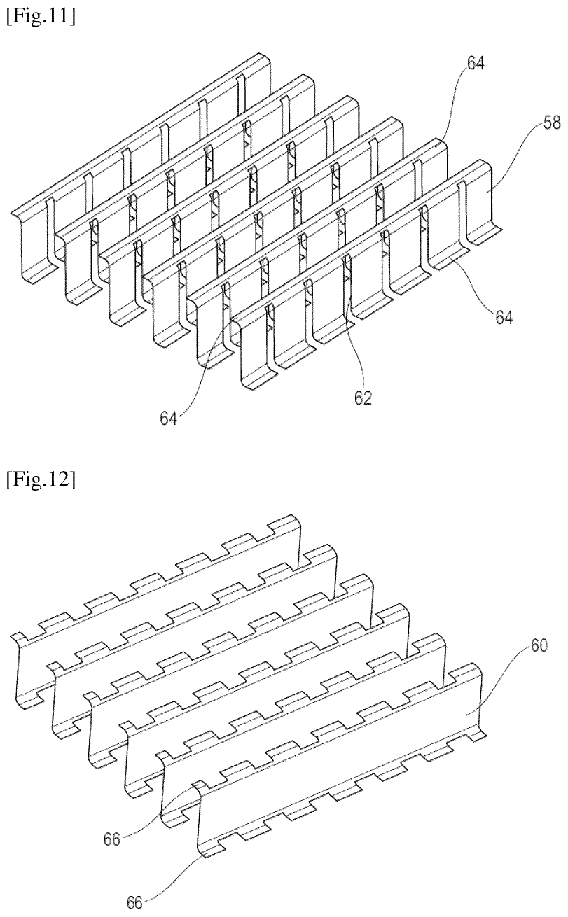

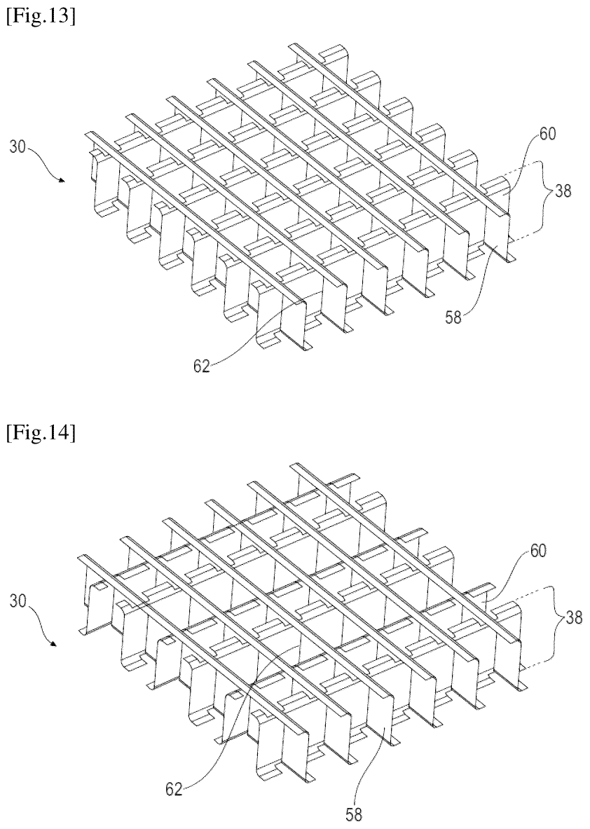

According to a second embodiment of the central core 30 shown in FIG. 13, the central core 30 comprises a single layer 38 formed of a grid comprising an arrangement of first blades 58 parallel to one another, and second blades 60 parallel to one another, the second blades 60 being substantially perpendicular to the first blades and embedded in the first blades 58. FIG. 11 shows the first blades 58, which comprise notches 62 at regular intervals configured to receive the second blades 60 and space them evenly apart. FIG. 12 shows the second blades 60.

Both the first blades 58 and the second blades 60 comprise a Z-shaped profile. The first blades 58 thus comprise horizontal end tabs 64, and the second blades 60 comprise horizontal end tabs 66. It is these tabs 64, 66 which allow the central core 30 to be attached to the skins 26 or 28 by welding or brazing.

It will be noted that two arrangements may be envisaged, i.e. either the second tabs 60 are all oriented in the same direction as shown in FIG. 13, or they are oriented head to tail as shown in FIG. 14.

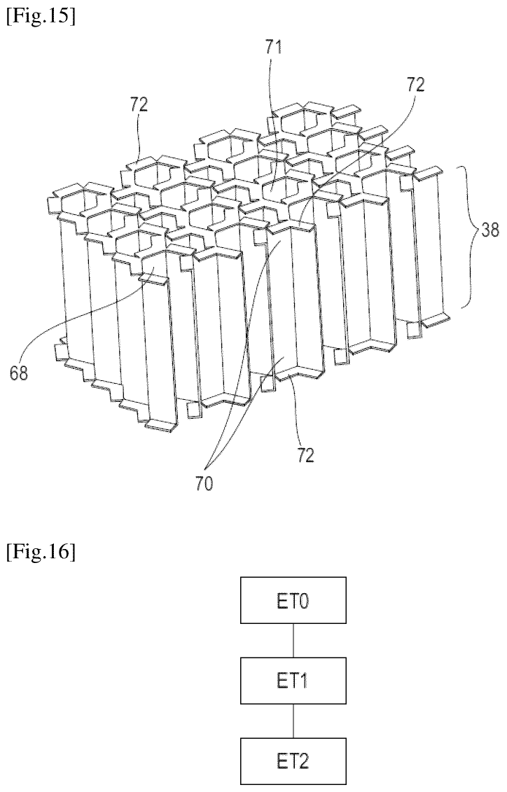

In a third embodiment of the central core 30 shown in FIG. 15, the central core 30 comprises a single layer 38 of tubular honeycomb grooves 68, preferably but not restrictively hexagonal, the ends 70 of which comprise dropped edges 72. These dropped edges 72 are connected to the first and second skins 26, 28 respectively, as before, by welding, brazing or gluing.

The invention therefore proposes an aircraft propulsion assembly comprising a panel 24 which has numerous advantages over panels known in the prior art.

In the particular case of metal panels 24, the panels 24 are initially lighter, since the central core and the second skin 28 are made of aluminum alloy. The first skin 26, made of T40/T60 titanium, is also cooler thanks to the thermal conduction of the central core 30 and the second skin 28.

In the particular case of thermoplastic panels 24, the skins 26 and 28 may advantageously be stamped with reduced manufacturing times, and moreover, when it is used, gluing is a short operation which allows to reduce the manufacturing times. The plastic panels 24 may also be repaired by welding between the acoustic second skin 28 and the material of the central core 30.

In any case, the panels 24 have reduced manufacturing times, which means lower costs.

1. A propulsion assembly for an aircraft, the propulsion assembly comprising:
a cowling panel installed in a high-temperature area of the propulsion assembly and providing a flameproof barrier, the cowling panel having a sandwich-like structure including:
a first skin;
a second skin; and
a central core connecting the first and second skins,
wherein the first skin is made of a single first material, the first material having properties of mechanical resistance to high temperatures and of flameproof barrier allowing the first skin to withstand up to a temperature of 150° C. to 400° C., and to be exposed directly to a flame without igniting or being passed through by the flame for at least 15 minutes,
wherein the second skin is made of a second material which is different from the first material and is without the properties of the first material, and
wherein the central core is made of one of the first and second materials or of a material different from the first and second materials.

2. The propulsion assembly according to claim 1, wherein the cowling panel is made of metallic materials and wherein:
the first skin is a titanium or stainless steel plate;
the central core comprises at least one layer of aluminum alloy comprising regularly distributed spacers extending between the first and second skins; and
the second skin is an aluminum alloy plate.

3. The propulsion assembly according to claim 2, wherein the first skin is able to withstand up to a temperature of 350° C. to 400° C.

4. The propulsion assembly according to claim 1, wherein the cowling panel is made of thermoplastic materials and wherein:
the first skin is a composite plate made of thermoplastic material with a glass transition temperature above 140° C.;
the central core comprises at least one layer of regularly distributed spacers extending between the first and second skins, the layer being made of a thermoplastic material having a glass transition temperature lower than that of the material of the first skin; and
the second skin is a plate made from the same thermoplastic material as the central core.

5. The propulsion assembly according to claim 4, wherein the first skin is made of Poly Ether Imide (PEI) and is able to withstand a temperature of 150° C. to 210° C.

6. The propulsion assembly according to claim 2, wherein each layer of the at least one layer comprises spacers each having the general shape of a hollow pyramid with a flat truncated top and an open base whose sides are connected to the sides of the bases of the adjacent spacers by a wall of the at least one layer which is parallel to the skins and which extends between the pyramids.

7. The propulsion assembly according to claim 6, wherein the central core comprises a single layer of spacers which is attached to the first skin by its wall and which is attached to the second skin by the flat truncated tops of its pyramids.

8. The propulsion assembly according to claim 6, wherein the central core comprises two superimposed layers, each layer being attached to a corresponding skin by its wall and the two layers being attached to each other by the flat truncated tops of their pyramids arranged head to tail.

9. The propulsion assembly according to claim 4, wherein at least one face of each of the pyramids comprises at least one acoustic perforation.

10. The propulsion assembly according to claim 2, wherein the central core comprises a single layer of tubular grooves in the form of honeycombs, the ends of which comprise dropped edges which are connected respectively to the first and second skins.

11. The propulsion assembly according to claim 2, wherein the central core comprises a single layer formed of a grid comprising an arrangement of first blades parallel to one another, and second blades parallel to one another, the second blades being substantially perpendicular to the first blades and embedded in the first blades.

12. A method for manufacturing a propulsion assembly according to claim 7, the method comprising at least one step of welding the first skin to the central core and at least one step of welding or brazing the second skin to the central core.

13. The method of claim 12, further comprising:
a first step of welding the single layer of the central core to the first skin, the welding being carried out by moving a welding tool over the wall of the layer along a predetermined path between the pyramids; and
a second step of brazing or gluing the second skin to the flat truncated tops of the pyramids of the single layer of the central core.

14. A method for manufacturing a propulsion assembly according to claim 8, the method comprising at least one step of welding the first skin to the central core and at least one step of welding or brazing the second skin to the central core, the method further comprising:
a first step of welding each of the two layers configured to form the central core to the first skin and the second skin respectively, the welding being carried out by moving a welding tool over the wall of each layer along a path between the pyramids of each layer; and
a second step of brazing between the flat truncated tops of the pyramids of each of the two layers to join them together and form the central core.

15. A method for manufacturing a propulsion assembly according to claim 10, the method comprising at least one step of welding the first skin to the central core and at least one step of welding or brazing the second skin to the central core, the method further comprising:
a first step of welding the central core to the first skin, the welding being carried out by a welding tool; and
a second step of brazing or gluing the second skin to the central core.

16. A method for manufacturing a propulsion assembly according to claim 11, the method comprising at least one step of welding the first skin to the central core and at least one step of welding or brazing the second skin to the central core, the method further comprising:
a first step of welding the central core to the first skin, the welding being carried out by a welding tool; and
a second step of brazing or gluing the second skin to the central core.
